(19) United States
(12) Patent Application Publication
(10) Pub. No.: US 2024/0079837 A1
(43) Pub. Date: Mar. 7, 2024

(54) UNIVERSAL TOOL FOR SOLAR PV MODULE ELECTRICAL CONNECTORS

(71) Applicants: Joe Bingham, Lethbridge (CA); Joshua Bingham, Stirling (CA)

(72) Inventors: Joe Bingham, Lethbridge (CA); Joshua Bingham, Stirling (CA)

(21) Appl. No.: 17/902,019

(22) Filed: Sep. 2, 2022

(51) Int. Cl. H02S 40/36

(52) U.S. Cl. CPC H02S 40/36

(57) ABSTRACT

A tool for disconnecting solar PV module cable electrical connectors is configured to be used with different styles of electrical connectors, thereby being a universal tool. The tool has flat handle having a first section, a second section that is positioned at an angle to the first section, a first end having a pair of spaced apart parallel tines positioned at a right angle to the second section, and a third section terminating at a second end. The third body section tapering from wide to narrow in a direction from the first body portion toward the second end. The tines are specifically configured to cooperate with different styles of connectors to engage the latch fingers and depress the fingers, allowing the connector bodies to be separated.

### FIELD OF THE INVENTION

The present invention relates to tools for electrical connectors and, more particularly, the invention pertains to a tool for different types of electrical connectors used for electrically connecting solar photovoltaic modules.

### BACKGROUND OF THE INVENTION

Electrical connectors are used in solar power applications to connect solar photovoltaic (PV) modules (solar panels) together in electrical arrays. The electrical connectors comprise a single-contact male and female connector pair that are releasably connectable. Generally, one connector, usually the female connector, has two plastic fingers that need to be pressed inwardly to permit joining the female and male connectors. When the two connectors are pushed together, the fingers slide along the male connector until they reach a notch or opening in the side of the male connector, where they pop outward to lock the two connectors together. A tool is required to depress the fingers and allow decoupling the female and male connectors.

There are differently styles of Solar PV module electrical connectors. While the different styles of connectors share similar finger-notch locking structures, they have different male and female connector body configurations or shapes. Heretofore, each style of electrical connector has its own tool that is specifically configured for use with the specific shapes of the connector bodies forming the electrical connector. Stated differently, a tool for one style connector cannot be used with a differently style connector. This requires a technician to carry or have on hand separate tools for each style of electrical connector, which is undesirable.

Accordingly, there is a need and a desire for a single tool that can be used universally with different styles electrical connectors and, particularly, with differently styled solar PV module cable electrical connectors.

### SUMMARY OF THE INVENTION

Embodiments of the invention solve the foregoing described need and desire for a single tool that can be used for disconnecting differently styled electrical connectors for solar PV modules.

An object of embodiments of the present invention is to provide a single tool having a specific configuration that is universal to different styles of electrical connectors.

Another object of embodiments of the present invention is to provide such a tool that is constructed from metal.

In one aspect, such a tool comprises an elongated, flat handle having a first section, a second section that is positioned at an angle to the first section, a first end having a pair of spaced apart parallel tines positioned at a right angle to the second section, and a third section terminating at a second end. The third body section tapering from wide to narrow in a direction from the first body portion toward the second end. The tines are specifically configured to cooperate with different styles of connectors to engage the latch fingers and depress the fingers, allowing the connector bodies to be separated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is an isometric view of an electrical connector tool that is constructed in accordance with an embodiment of the invention;

FIG. 2 is a top plan view of the tool;

FIG. 3 is a side elevation of the tool;

FIG. 4 is an enlarged first end elevation view of the tool;

FIG. 5 is an enlarged second end elevation view of the tool;

FIG. 6 is a bottom plan view of the tool;

FIG. 7 is a top plan view of the tool, showing the tool in use with a first electrical connector;

FIG. 8 is a top plan view of the tool, showing the tool in use with the first electrical connector;

FIG. 9 is a top plan view of the tool, showing the tool in use with a second electrical connector; and

FIG. 10 is a top plan view of the tool, showing the tool in use with the second electrical connector.

### DETAILED DESCRIPTION OF THE INVENTION

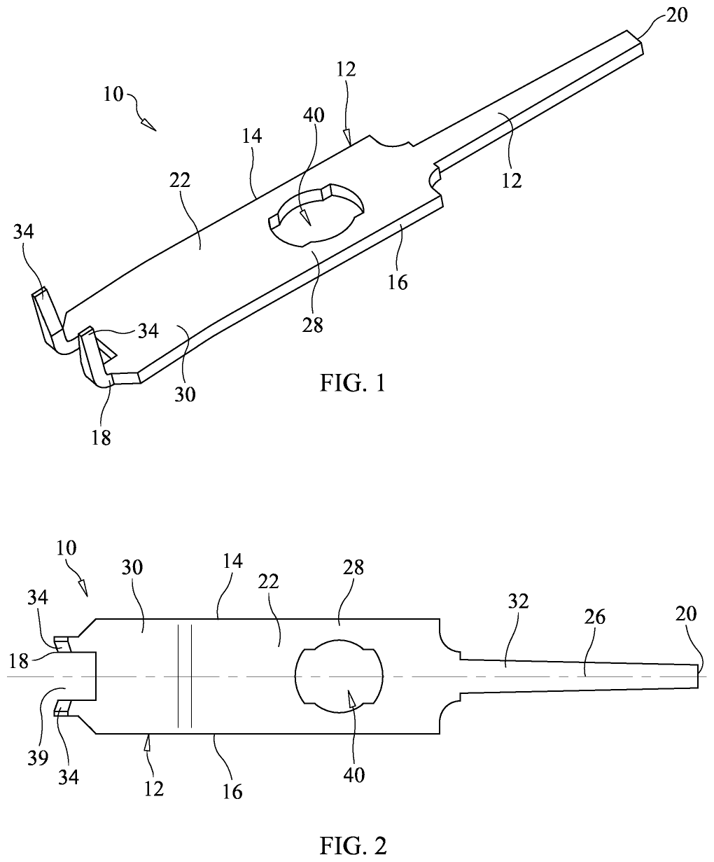

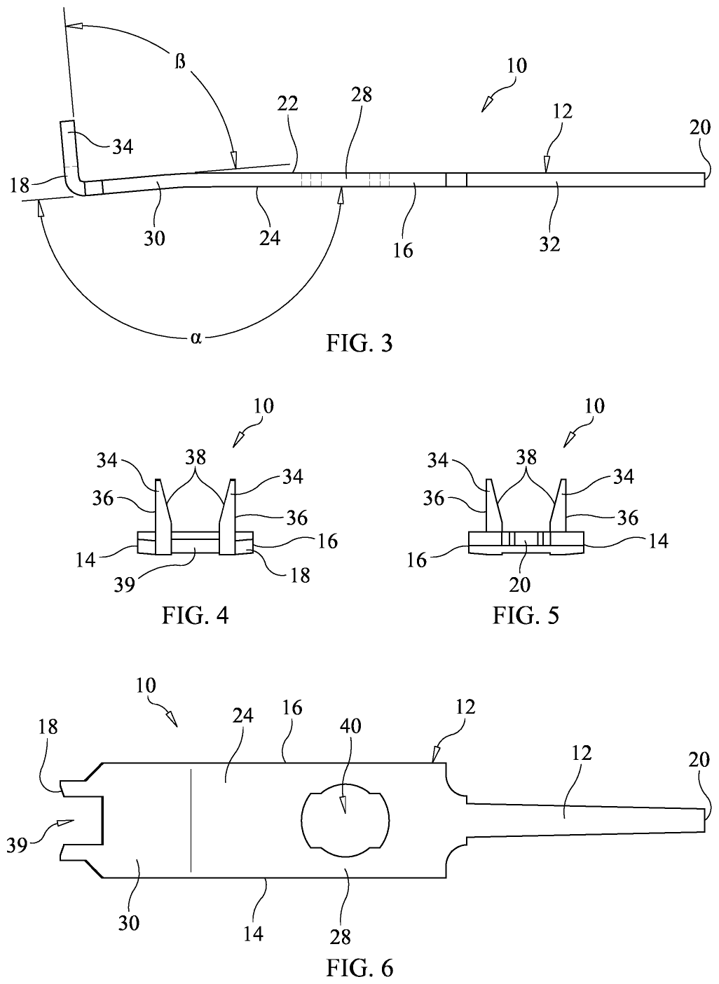

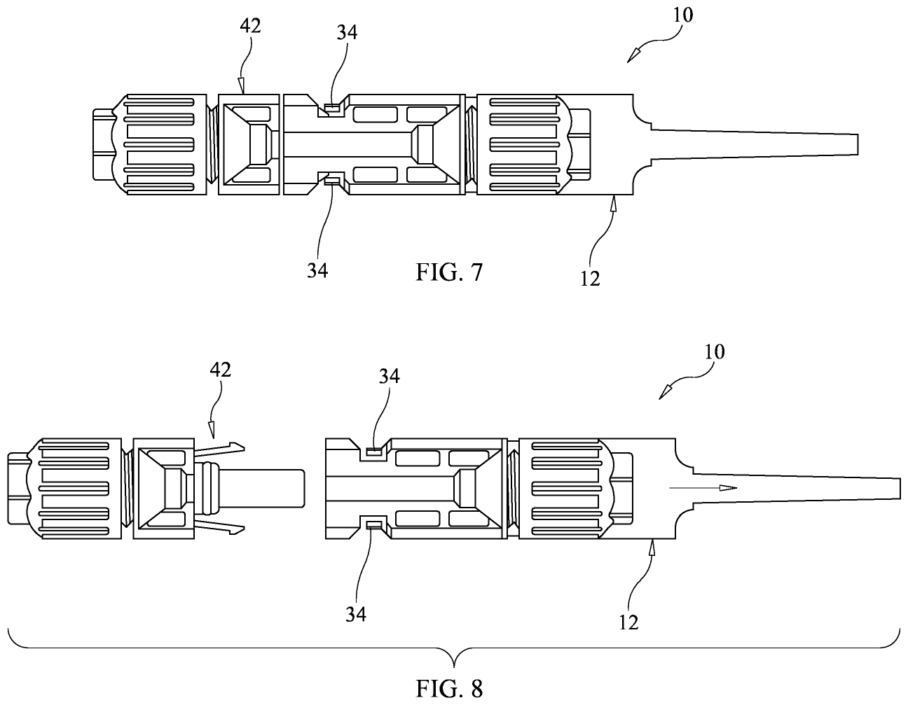

Initially, with reference to FIGS. 1 through 6 of the drawings, reference number 10 generally designates an electrical connector tool that is constructed in accordance with an embodiment of the invention. In an aspect, the tool 10 can be used to disconnect electrical connectors that have a male and a female connector pair that are releasably connectable. The tool 10 is particularly configured for use with different styles of solar PV module cable electrical connectors, such as, for example MC4 type and the like connectors. The tool 10 provides the advantage of a single tool that can be used with different style connectors, thereby eliminating the need to carry several different tools, each for a different style connector. In other words, tool 10 is a universal tool capable of use with differently configured solar PV module cable electrical connectors.

The tool 10 comprises an elongated handle 12, which can be made from flat steel stock, for example, 0.125-inch-thick steel. The handle 12 has first and second generally parallel spaced sides 14 and 16, first and second ends 18 and 20, and opposite broad surfaces 22 and 24. A longitudinal axis 26 extends between the first and second ends 18 and 20. The handle 12 further has a first section 28, a second section 30, and a third section 32. The second and third sections 30 and 32 are disposed on opposite ends of the first section 28, as depicted in the drawings.

The second section 30 is bent or positioned at a first angle α to the first section 28. In an aspect, the first angle α is about 175-degrees. The first end 18 has a pair of laterally spaced apart parallel tines 34 that are positioned at a second angle β to the second section. In an aspect, the second angle β is about 90-degrees or a right-angle. Each tine has tip, a base, a laterally facing outward surface 36, and an inward surface 38 opposite of the outward surface. In an aspect, each tine 34 is generally wedge-shaped as viewed from the first end in elevation with the inward surface 38 tapering from the top toward the base. A notch 39 is formed through the first end 18 and positioned between the tines 34.

As explained in further detail below, the tines 34 are specifically configured to engage the plastic fingers of a first connector member (i.e., the female connector) to press the fingers inwardly to allow disconnecting the first connector member from a second connector member (i.e., the male connector). Importantly, the specific configuration of the tines 34 allows the tool 10 to be used with different styles of electrical cable connectors, as also explained further below. That is, tool 10 is a universal tool that can be used to disconnect the connector pairs of differently styled electrical connectors. And, more specifically, differently styled solar PV module cable electrical connectors, such as, for example MC4 type connectors.

To achieve the universal application of tool 10, a particular configuration of the tines 34 is required. In an aspect, to meet the requirement, the tips of the tines are spaced about 0.68 inches apart and each tine has a length of about 0.53 inches. This tine configuration allows the tines 34 to be able to engage the fingers of more than one style of MC4 type connector.

The third section 32 tapers from wide to narrow in a direction from the first section 28 toward the second end 20. As shown, the third section 32 at its connection with the first section 28 has a width that is less than the width of the first section.

A notched hole 40 is disposed through the broad faces of the first section 28. The notched hole 40 is configured to receive and hold the male and female connectors against rotating to allow attaching a cable end to the connector in a manner that is known in the field of the invention.

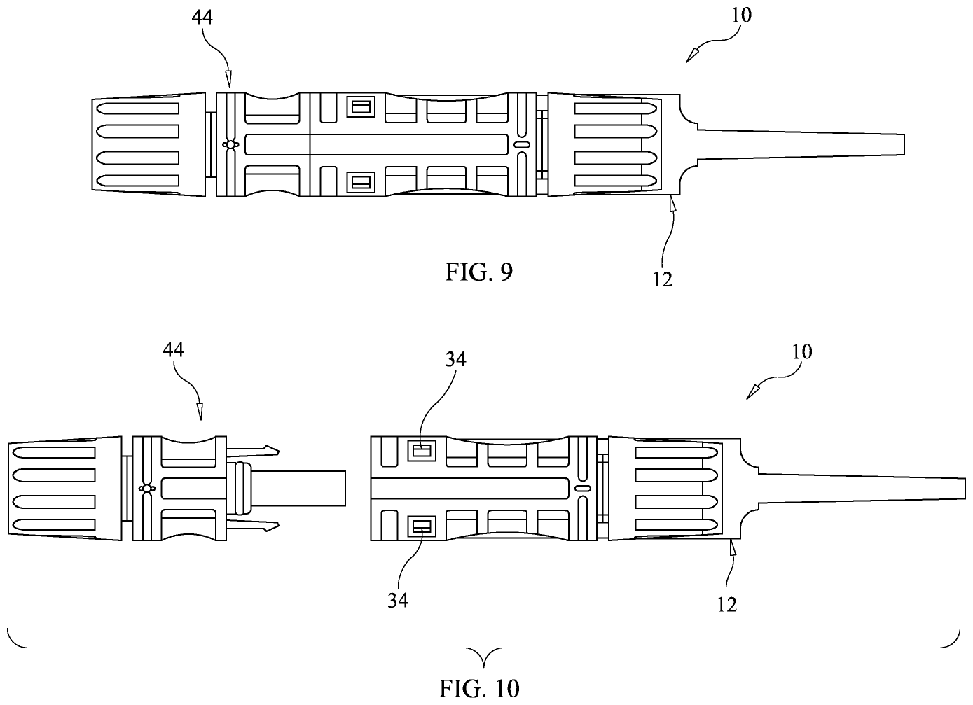

With reference to FIGS. 7-10, the universal aspect of tool 10 is demonstrated. Particularly, in FIGS. 7 and 8, tool 10 is shown in use with an electrical connector 42 and, in FIGS. 9 and 10, the tool is shown in use with an electrical connector 44. Both electrical connectors 42 and 44 share a similar finger-to-notch latch that locks the female and male connectors in a connected state. However, the shape of the female and male connector bodies is different between the two electrical connectors 42 and 44, as can be seen in the drawings. However, despite the different shapes between the two connectors, the specific configuration of the tool 10 and, particularly, the tines 34, allows the tool to be used with both style connectors. That is the specific configuration of the tines 34 allows the tines engage with the fingers of each connector even though they don't share the same connector body shapes. Additionally, the bend in the handle 12 provides leverage that helps a user to pull the connector bodies apart.

While the invention has been particularly shown and described with respect to the illustrated embodiment thereof, it will be understood by those skilled in the art that the foregoing and other changes in form and details may be made therein without departing from the spirit and scope of the invention.

What is claimed is:

1. An electrical connector tool, comprising:
an elongated, flat handle having a first section, a second section that is positioned at an angle to the first section, a first end having a pair of spaced apart parallel tines positioned at a right angle to the second section, and a third section terminating at a second end, the third body section tapering from wide to narrow in a direction from the first body portion toward the second end.

2. The electrical connector tool of claim 1, wherein the tool is comprised of metal.

3. The electrical connector tool of claim 1, wherein each tine has tip, a base, a laterally facing outward surface, and an inward surface opposite of the outward surface, and wherein the inward surface is tapered from the tip toward the base.

4. The electrical connector tool of claim 1, further comprising a notch in the first end between the pair of tines.

5. The electrical connector tool of claim 1, wherein the angle is about 175 degrees.

6. The electrical connector tool of claim 1, wherein the tips of the tines are spaced apart about 0.68 inches.

7. The electrical connector tool of claim 1, wherein a thickness of the handle is about 0.125 inches.

8. An electrical connector tool, comprising:
an elongated, flat handle constructed of metal, the handle having a first section, a second section that is positioned at an angle to the first section, a first end having a pair of spaced apart parallel tines positioned at a right angle to the second section, and a third section terminating at a second end, the third body section tapering from wide to narrow in a direction from the first body portion toward the second end;
wherein each tine has tip, a base, a laterally facing outward surface, and an inward surface opposite of the outward surface, and wherein the inward surface is tapered from the tip toward the base; and
wherein the handle has a notch in the first end between the pair of tines.

9. The electrical connector tool of claim 8, wherein the angle is about 175 degrees.

10. The electrical connector tool of claim 8, wherein the tips of the tines are spaced apart about 0.68 inches.

11. The electrical connector tool of claim 8, wherein a thickness of the handle is about 0.125 inches.
